(19) United States
(12) Patent Application Publication
(10) Pub. No.: US 2015/0212316 A1
(43) Pub. Date: Jul. 30, 2015

(54) DEVICE FOR PLACING AN OBJECT IN AT LEAST A FIRST AND A SECOND ORIENTATION OR SPATIAL LOCATION

(71) Applicant: UNIVERSITAT ZURICH, Zurich (CH)

(72) Inventors: Madhavi Krishnan, Zurich (CH); Michele Celebrano, Codogno (Lodi) (IT)

(73) Assignee: UNIVERSITAT ZURICH, Zurich (CH)

(21) Appl. No.: 14/424,445

(22) PCT Filed: Aug. 29, 2013
(86) PCT No.: PCT/EP2013/067950

§ 371 Date: Feb. 27, 2015

(30) Foreign Application Priority Data
Aug. 31, 2012 (EP) 12182672.1

(51) Int. Cl. G02B 26/02; G02B 1/00

(52) U.S. Cl. CPC G02B 26/02; G02B 1/005; Y10S 977/774; Y10S 977/932; B82Y 20/00

(57) ABSTRACT

The invention relates to a device for orienting at least one object in at least a first or a second orientation or for placing it in a first or a second spatial location, comprising: a substrate (10) having a surface (10a), at least one object (3) levitated above said surface (10a),wherein the device (1) is designed to generate an e.g. electrostatic potential with help of the substrate (10) for trapping the at least one object (3), the potential having at least a first minimum and a second minimum, so that the at least one object (3) is oriented in the first orientation (or located in a first spatial location) when being trapped in the first minimum, and in the second orientation (or located in the second spatial location) when being trapped in the second minimum, and wherein said at least one object (3) is trapped in one of said minima.

The invention relates to a device for placing, particularly orienting, at least one object in at least a first or a second orientation or spatial location.

The shape and spatial arrangement of nano-objects in an assembly has profound effects on its interaction with light, and is a central theme in hybrid photonic devices, metamaterials and plasmonics.

The problem addressed by the present invention therefore is to provide for a device that enables one to efficiently define and alter the orientation of such objects, individually and/or collectively or for placing them in certain spatial locations.

According to the invention this problem is solved by a device having the features of claim 1.

According thereto, such a device for orienting at least one object in at least a first or a second orientation or for placing at least one object in at least a first or a second spatial location comprises a substrate having an e.g. planar surface, at least one (e.g. anisotropic) electrically charged object levitated above said surface, wherein particularly the at least one object is a nanophotonic element, i.e. an object on the nanometer scale that interacts with incident light, preferably having a wave length in the region of 300 nm to 1200 nm, wherein the device is designed to generate a potential, preferably an electrostatic potential (however, objects may also be levitated in such a fashion using other electromagnetic or thermodynamic interaction potentials, e.g. Van der Waals forces, depletion forces etc.), with help of the substrate interacting with said at least one object so as to trap the at least one object, the potential having at least a first minimum and a second minimum, so that the at least one object is oriented in the first orientation or placed in the first spatial location when being trapped in the first minimum, and is oriented in the second orientation (being different from the first orientation) or placed in the second spatial location when being trapped in the second minimum, and wherein said at least one object is trapped in one of said minima. The orientation may be expressed in terms of an angle of a certain axis of the object (e.g. its longitudinal axis) in a plane parallel to the extension plane of the surface with respect to some reference direction. Particularly, altering the orientation of the object corresponds to changing said angle. Thus, in the individual minima said object particularly comprises a certain angle (orientation) with respect to said reference direction.

Particularly said potential may form a “bi-stable” or even a “multi-stable” electrostatic potential well, i.e., a potential which has two (or in fact even three) angular minima that are separated by an energy barrier.

Particularly, said potential is generated such that it allows for at least two (or several, for instance three) equally likely orientations of an object separated by an energy barrier or that it allows for two different, particularly equally likely, spatial positions.

Preferably, the substrate further comprises at least one indentation in said surface for generating said potential.

Further, preferably, the device according to the invention comprises a layer of an electrolytic fluid phase wetting the surface of the substrate and the at least one indentation for generating said electrostatic potential, wherein particularly said fluid phase preferably has a low ionic strength, preferably around 0.1 mM, preferably below 0.1 mM in water. Generally, pure water under ambient conditions turns out to have about 0.1 mM ions in it. In order to use ionic strengths above 0.1 mM, which is also conceivable, one may add salts like KCl or NaCl in order to increase the ionic strength.

Particularly, the at least one object is levitated above said at least one indentation in said fluid phase due to the electric charge of the object

Furthermore, the device preferably comprises a transparent top layer for generating said potential extending along the surface of the substrate, wherein particularly said top layer is made out of a glass, wherein said layer of the fluid phase is confined between the surface of the substrate and said top layer.

It is to be noted however, that the device can also be arranged in a spatial position where the top layer is actually arranged below the substrate. Particularly, it is merely important that the fluid phase is arranged between the substrate and the top layer. The device may then also be arranged upside down (as done e.g. in experiments presented below). Thus the top layer may also simply be denoted as layer.

Such an electrostatic potential near the above-mentioned substrate (e.g. an SiO₂-surface), decays exponentially away from the surface value, Ψ₀ as Ψ₀=Ψ₀e^{-κz}, where κ⁻¹ is the “Debye length” and for a monovalent electrolyte in water is given by κ⁻¹=0.304/\sqrt{C}. Two charged planes separated by a gap 2 h in a fluid phase thus give rise to an electrostatic potential minimum midway between them. For low values of Ψ₀, the potential at the midplane due to both surfaces (substrate and top layer) can be taken to be simply additive and is given by Ψₘ=2Ψ₀e^{κh}. A local increase in the gap width of say d would give a local potential minimum of Ψₘ=2Ψ₀e^{-κ(h+d/2)}. So a point charge q (the charge of the at least one object/nanorod), traversing a width modulation in the gap would experience a change in electrostatic energy given by ΔU=2qΨ₀e^{-κh}(1=e^{-κd/2}). When d→0, i.e, the width modulation vanishes the slit consists of two flat parallel walls facing each other, ΔU→0. For large κd, on the other hand, ΔU=2qΨ₀e^{-κh}. While these simple considerations—based on linearization of the governing equations, which is valid only for low surface potentials or far away from surfaces—are not quantitatively exact, they give a physical picture of how geometrical modulation of a gap can translate to a modulation of the electrostatic potential in a fluid. They also furnish key insight into optimal design of electrostatic landscapes to trap and manipulate single charged particles in fluids. Accordingly, systems with small values of κh and walls with a high surface potential, Ψ₀ would be expected to work best in creating deep local potential wells, capable of retaining a charged object for a long time. Furthermore, under a given set of conditions, i.e. ionic strength, particle and slit depth, the shape and depth of each local potential well can be tailored using the geometry of the surface indentation.

According to an aspect of the present invention the at least one indentation comprises at least a first and a second indentation region. Particularly, each indentation region comprises a boundary contour delimiting the respective indentation region, wherein said boundary contours each mimic a contour of the at least one object in a plane extending along the surface of the substrate. For instance, when said at least one object has an elongated shape (length larger than width), the indentation regions also comprise an elongated shape.

In an embodiment of the invention, the first indentation region extends longitudinally along a first extension direction (i.e. its length along the first extension direction is larger than its width across the first extension direction), wherein the second indentation region goes off a free end of the first indentation region or is separated from the first indentation region (i.e. the two indentation regions may be arranged close to one another but do not need to be connected to each other) and extends longitudinally along a second extension direction (i.e. its length along the second extension direction is larger than its width across the second extension direction), wherein when being oriented in the first orientation the object is levitated above the first indentation region and aligned with the first indentation region, and wherein when being oriented in the second orientation the object is levitated above the second indentation region and aligned with the second indentation region.

Preferably, the second extension direction runs perpendicular to the first extension direction, so that said the contour delimiting the at least one indentation particularly comprises an L-shape or a T-shape in the extension plane of the surface of the substrate. The limbs of such an L-shape or T-shape, i.e., said first and second indentation regions do not need to intersect (see above).

According to a further embodiment, said potential has a further third minimum so that the at least one object is oriented in a third orientation when being trapped in the third minimum. Particularly, the at least one indentation comprises a third indentation region, particularly going off said (common) free end, wherein however the third indentation region can also be separated from the other indentation regions, see above), wherein when being oriented in the third orientation the at least one object is levitated above the first indentation and aligned with the first indentation region. Preferably, the third indentation region encloses an angle with first and second indentation region of 135°, respectively, so that said at least one indentation comprises a Y-shape.

Preferably, said object is formed as an elongated object extending along a longitudinal axis, particularly as a nanorod, particularly comprising a length within the range from ˜1 nm to ˜1 μm, particularly comprising a width across the longitudinal axis in the range from ˜1 nm to ˜1 μm. Such a nanorod may have a cigar or ellipsoidal shape. Preferably, the aspect ratio between length and width is around (preferably equal to) or larger than 2. In case of such elongated objects, the indentation regions preferably have an elongated rectangular shape (i.e. are formed as elongated rectangular pockets).

Particularly, when aligned with an indentation region, the longitudinal axis of the at least one object, along which the latter has the largest dimension, runs—besides fluctuations—parallel to the extension direction of the respective indentation region.

Preferably, said at least one object is designed such that it scatters light strongly when its longitudinal axis is aligned with the polarization of incident light (bright state) and such that it does not scatter light (dark state) in case its longitudinal axis is oriented orthogonal to the polarization of incident light.

This orientation dependent optical property of the at least one object may be due to a Plasmon resonance of the at least one object, which is sensitive to a property of light such as its polarization.

Therefore, the device according to the invention can be used for designing a display.

In this regard the device according to the invention preferably comprises a means for illuminating the at least one object with light having a polarization extending along the first orientation, particularly parallel to the first extension direction, so that the at least one object scatters said light strongly, i.e. constitutes a bright state, when being trapped in the first minimum, and does not scatter light or does scatter less light when being trapped in the second minimum (dark state). Such a means may be formed by an additional light source radiating light having said polarization or by said top layer or a coating thereof, which only lets through ambient light having said polarization.

According to a further embodiment of the present invention the object is an (e.g. electrically charged) quantum dot, wherein particularly said quantum dot is spherically symmetric.

Such a quantum dot is a semiconductor nanocrystal capable of absorbing light at a particular frequency and emitting light at a different (e.g. lower) frequency. Typical quantum dots are made of binary alloys such as cadmium selenide, cadmium sulfide, indium arsenide, and indium phosphide. Quantum dots can contain as few as 100 to 100,000 atoms within the quantum dot volume, with a diameter of 10 to 50 atoms. This corresponds to about 2 to 10 nanometers. Particularly, they are fabricated by colloidal synthesis and the surface is typically chemically functionalized for various applications. Particularly, quantum dots with surface functionalization that renders a net charge to their surface in a fluid are commercially available and are the object of interest in this application.

Preferably, the device is designed to provide a local dielectric environment at the first spatial location and a local dielectric environment at the second spatial location, wherein the two dielectric environments differ from each other, so that the quantum dot is able to emit light away from the substrate when being trapped in the first minimum and is not able to emit light away from the substrate or less light (compared to the first spatial location) away from the substrate when being trapped in the second minimum.

The local dielectric environment is given by materials (e.g. of the substrate or top layer) in the immediate vicinity of the object in the given spatial location (one may also call this the local electromagnetic environment). Particularly, the fluid phase is a dielectric material, so it too is a part of the local dielectric environment.

The potential, particularly electrostatic potential may be generated with help of two indentation regions which may form separate indentations of the substrate, wherein e.g. the substrate adjacent to the respective indentation region is preferably designed such that said different dielectric environments are generated at the two spatial locations. This can be done e.g., by choosing the composition of the substrate adjacent to the respective indentation region such that said different dielectric environments being characterized by the value(s) of the dielectric function or relative permittivity in the respective environment arise.

In this way, the indentation regions are designed to produce two different photophysical states such that the quantum dot in such a double-well is bright in one state (i.e. in the first spatial location) and dark in the second state (i.e.in the second spatial location). Thus, the intensity modulation would not be due to a change in angular orientation with respect to the illumination field as for nanorods for example, but rather due to the emission properties of the quantum dot which is a strong function of the respective dielectric environment. Here, locally different substrate materials may be used to realized said different photophysical states (see above), rather than indention (pocket) geometry alone, as is the case for e.g. nanorods.

By means of the dielectric environment at the first spatial location one can achieve that the quantum dot when being trapped in the first minimum where the quantum dot is levitated in said layer of the fluid phase above the first indentation region and resides in said first spatial location emits light away from the substrate when excited by suitable electromagnetic radiation while by means of the dielectric environment at the second spatial location one can achieve that the quantum dot when being trapped in the second minimum where the quantum dot is levitated in said layer of the fluid phase above the second indentation region and resides in said second spatial location emits light mainly or completely towards the substrate and thus no light or comparably less light away from the substrate when excited by suitable electromagnetic radiation.

The local electromagnetic environment can have a profound influence on the electronic excitations in an atom, molecule or discrete object. The available quantum mechanical states determine whether certain electronic transitions are possible or not as well as their probabilities. Thus electronic transitions whose energy lies in the optical regime result in absorption or emission of light by an entity. The probabilities of these transitions can be tuned using the local environment, selectively switching on and off the emission of the entity in response to illumination by an excitation field. We term the “density of states” approach. Another scheme we envision is based on modification of radiation patterns depending on the local dielectric environment. In free space a dipole has the classic Hertz dipole radiation pattern. On closely approaching an interface, this pattern changes dramatically resulting in different amounts of energy emitted into each half space. For example, optic fibers are nothing but dielectric waveguides, where light is confined to the central high index medium by total internal reflection and cannot escape into the outer low-index medium (air). Similar principles apply to an emitter such as a quantum dot sandwiched in a dielectric medium (here the fluid phase), with different dielectric media above and below. Judicious choice of materials and local nanostructuring can result in differential deposition of emitted optical energy into the upper and lower half spaces. This dramatically influences the measured optical signal in the transmission or reflection.

Particularly, when using the device with a quantum dot in the context of a display or a switch, a means for exciting the at least one quantum dot with electromagnetic radiation is preferably provided, such that the at least one quantum dot emits light away from the substrate when being trapped in the first minimum and excited by said means, and such that the at least one object emits no light or less light away from the substrate when being trapped in the second minimum and excited by said means.

Particularly, with regard to the use of this device in the context of a display, but also when using the device as a storage means, the device according to the invention preferably comprises a switching means being designed to exert a torque or a force on the at least one object so as to alter the orientation of the at least one object from one of said orientations to another one of said orientations being a desired orientation or in order to displace the at least one object (e.g. quantum dot) from a current spatial location (first or second spatial location) to the other spatial location being a desired spatial location.

In a variant of the invention, said switching means is designed to generate an electromagnetic radiation exerting said torque or a force on the at least one object, wherein particularly said switching means comprises a laser for generating said electromagnetic radiation (laser light), wherein particularly for switching the orientation of the at least one object from the one of said orientations to said desired orientation said switching means is designed to generate electromagnetic radiation having a polarization extending along said desired orientation, particularly parallel to the longitudinal axis of the at least one object when the latter resides in the desired orientations or along the respective extension direction of the indentation region associated to the desired orientation.

In a variant of the invention a red-detuned laser, i.e., a laser at a lower frequency than the peak (plasmon) resonance of the at least one object (e.g. nanorod) is used, having ˜25 mW in the laser focus. Particularly the TEM00 mode (Gaussian intensity distribution) of an IR laser at 1064 nm is used.

In an alternative variant of the invention said switching means is designed to generate an electric field exerting said torque or force on the at least one object, wherein particularly said switching means comprises at least a first electrode for generating said electric field, wherein particularly said electrode is arranged (integrated) on the substrate, particularly adjacent to the indentation associated to the at least one object (above which the at least one object is levitated). Particularly, there is also provided at least a second electrode forming a counter electrode to said first electrode that is particularly also arranged adjacent the individual indentation, so as to generate an electric field between these two electrodes that moves the object over from one orientation to another (e.g. neighboring) orientation (e.g. from the first indentation region to the second indentation region etc.) or displaces the object (e.g. quantum dot) from one spatial location to the other spatial location (e.g. from the first indentation region to the second indentation region etc.). Particularly, a first (e.g. ground) electrode may be provided adjacent to the indentation (for instance in case of an L-shaped indentation between the two indentation regions, particularly where they meet each other), wherein a second electrode may be arranged along each indentation region, particularly on an opposite side of the respective indentation region with respect to the first electrode, so that an electric field between a first and a second electrode moves the individual object over to the neighboring indentation region (orientation). In case of a Y-shaped indentation (see above) an electrode may be arranged between each two indentation regions, so that particularly pairs of electrodes are formed facing each other across the respective indention region.

In case of a quantum dot the electrode positions can be the same as for a nanorod, for instance. As a guidline, the net electric field vector needs to be oriented along the virtual line connecting the geometric centers of the two potential minima or indention regions. For instance, in an embodiment, said first electrode may be arranged such that it is aligned with said line. In case of a second electrode forming the counter electrode said indentation regions may be arranged between the two electrodes.

According to a further aspect of the invention, particularly in the context of displays or data storage devices, the device comprises a plurality of objects, each object being levitated above said surface, wherein the device is designed to generate an electrostatic potential for each of said objects with help of the substrate for trapping the respective object, the potentials having at least a first minimum and a second minimum, so that each object is oriented in the first orientation when being trapped in the first minimum, and oriented in the second orientation when being trapped in the second minimum, and wherein each object is trapped in one of said minima, or so that so that each object is located in the respective first spatial location when being trapped in the respective first minimum, and located in the respective second spatial location when being trapped in the respective second minimum, and wherein each object is trapped in one of said minima, wherein particularly the substrate comprises a plurality of indentations or a plurality of groups of indentations in said surface for generating said potential, each indentation or group of indentations being associated to one of the objects, wherein particularly said layer of the (e.g. electrolytic) fluid phase wets the substrate and said indentations or groups of indentations formed therein for generating said potentials, wherein particularly each object is levitated above the respective indentation or group of indentations in said fluid phase, wherein particularly said objects are formed as elongated objects extending along a longitudinal axis, particularly as nanorods, or as quantum dots(see above).

Preferably, said indentations or group of indentations are arranged so as to form an array of indentations or group of indentations, wherein said indentations or groups of indentations are particularly arranged on the nodes of a 2D lattice, particularly a square lattice. In the framework of a display one may assign one or a plurality of such objects to a pixel of the display.

For instance, one may at least assign three objects to a single pixel of the device (display), for generating an RGB color pixel, e.g. three different nanorods, wherein the nanorods can be chosen such that they have the corresponding resonances in the red, green and blue range of the spectrum. Addressing these nanorods individually then allows for changing the color of the pixel.

Preferably, when using electromagnetic radiation for switching, the switching means is designed to scan said objects one after the other with the electromagnetic radiation for exerting a torque or force on selected objects so as to switching the orientation of the selected objects from their current orientation to a desired orientation (e.g. by means of said torque, particularly in case of nanorods) or by displacing selected objects from one spatial location to the respective other spatial location (e.g. by means of said force, particularly in case of quantum dots).

When using electric fields for switching a plurality of objects (e.g. nanorods or quantum dots), the switching means preferably comprises a plurality of electrodes, which may be configured as described above. For instance a pair of electrodes may be associated to each indentation region for turning the object to e.g. a neighboring orientation/indentation region by means of an electric field between said electrodes. Other arrangements of electrodes are also conceivable as long as they permit for generating an electric field that exerts a torque or force on an individual object that allows for switching the object over to another orientation. Preferably, the electrodes are each arranged on or integrated into the substrate adjacent to the associated indentation.

When several objects or a whole array are to be switched concerning orientation (e.g. in case of elongated objects such as nanorods) or displaced from the first or second spatial location to the respective other spatial location (e.g. in case of spherically symmetric objects such as quantum dots) in a concerted fashion, an electrode or a pair of electrodes may be used that need not be arranged adjacent to said indentation regions. This may be particularly employed for optical components eg, polarizers etc.

According to an aspect of the invention, the substrate comprises or is made out of SiO₂. Further, the top layer preferably comprises or is made out of a glass.

Preferably, the fluid phase is formed by a solvent of organic or aqueous composition (for instance deionized water).

Further, according to a further aspect of the invention, a display for optically displaying information such as text and graphics etc. is provided, wherein the display comprises a (trapping) device according to the invention.

Further, according to a further aspect of the present invention, a data storage device is provided, wherein the data storage device comprises a (trapping) device according to the invention.

Further, according to a further aspect of the present invention, a reconfigurable optical element is provided, wherein the reconfigurable optical element comprises a device according to the invention.

Summarizing, the invention particularly allows for orienting at least one e.g. nano-scale object using an electrostatic fluidic trap (formed by the substrate having an indentation—or more than one indentation for switching—associated to said object, the fluid phase layer and the top layer), whose morphology is particularly tailored to mimic the object's shape. This method offers high spatial and angular precision, is independent of the object's dielectric function and can be massively parallelized. Furthermore, each levitating entity may be individually manipulated using external fields, e.g. optical or electrical, which allows for the design of high resolution displays, non-volatile optical memories (data storage devices) and reconfigurable 2D metamaterials, while providing a versatile chip-based light-mechanics platform at the nano-scale.

Further features and advantages of the invention shall be described by means of detailed descriptions of embodiments with reference to the Figures, wherein

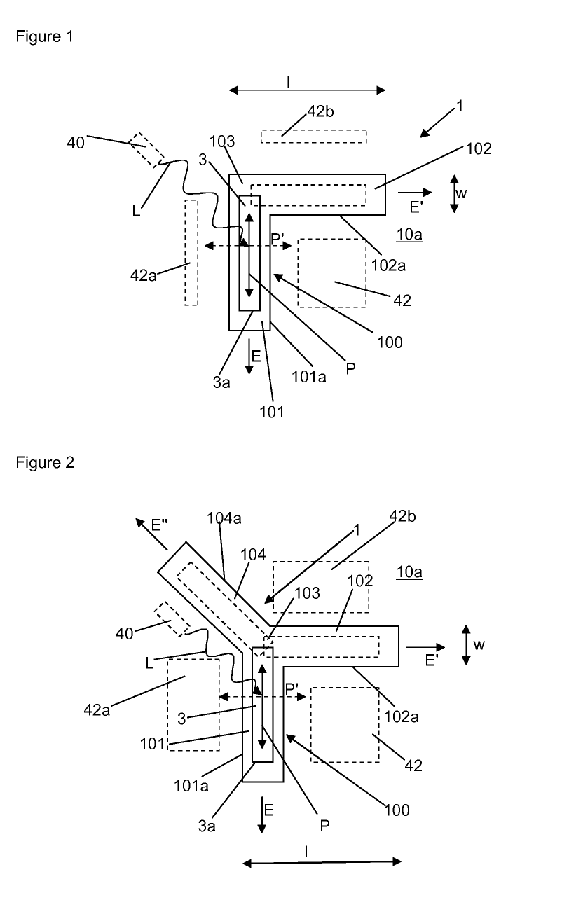

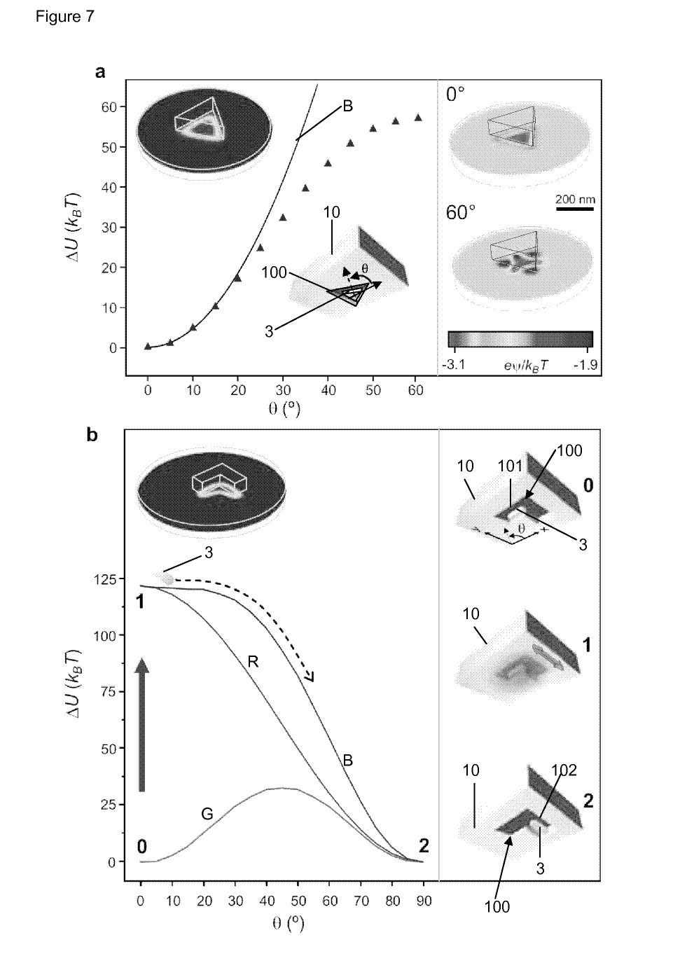

FIG. 1 shows a device according to the invention having an L-shaped indentation generating a bi-stable potential well of the kind shown also in FIG. 7;

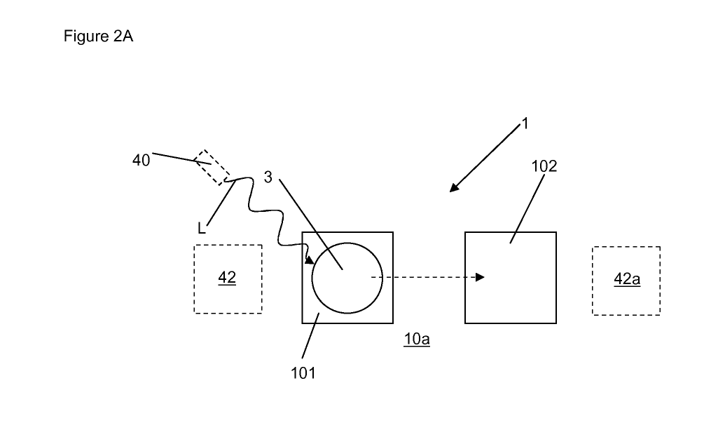

FIG. 2 shows a device according to the invention having an Y-shaped indentation generating a tri-stable potential well;

FIG. 2A shows a device according to the invention using a spherically symmetric quantum dot as levitated object;

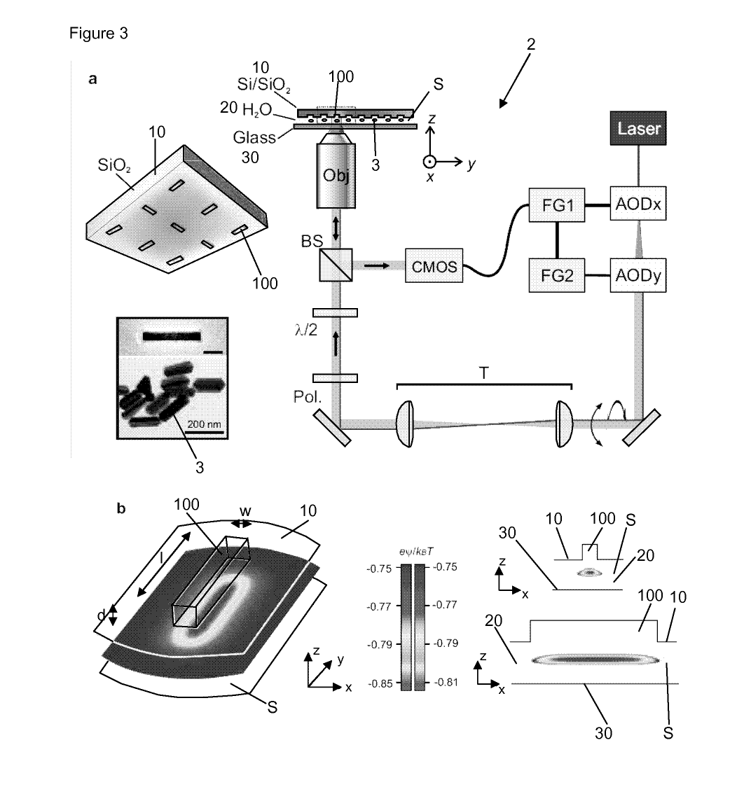

FIG. 3 shows an experimental set up for probing the orientation of a trapped nanorod 3 and the geometry of a cigar-shaped nanorod indentation 100 also denoted as pocket. a, Schematic of the laser scanning microscope set-up 2 and fluidic device 1 used to probe the orientation of single trapped gold nanorods 3 in an assembly. Also presented are electron micrographs of the rectangular indentation in the substrate (Scanning Electron Microscopy also denoted as SEM) and silver nanorods (Transmission Electron Microscopy also denoted as TEM) used in the study. b, Calculated spatial electrostatic potential distribution in the xy plane arising due to an indentation (pocket) 100 of length, l=600 nm, width, w=100 nm and depth 100 nm, in a slit of depth, 200 nm (left). The section displayed represents the plane of the electrostatic minimum in the axial dimension which occurs at z=110 nm above the floor of the slit in this geometry. Slit and pocket (indentation) depths are held constant in this study. Cross-sectional views of the potential distribution in the xz and yz planes are also displayed (right);

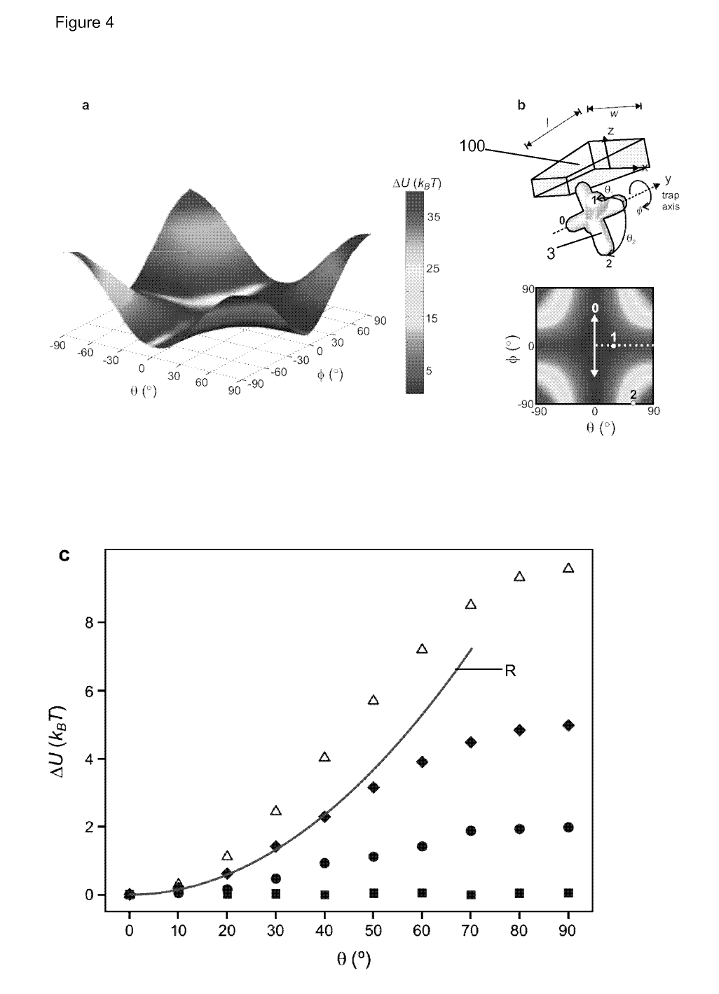

FIG. 4 shows the free energy for an ellipsoid (object) 3 as a function of its angular orientation (θ, Φ) in a cigar-shaped trap. a, 3D surface plot of the angular free energy of an ellipsoid 3 of dimensions 160 nm×60 nm, carrying a total charge of −255 e and trapped by a rectangular pocket (indentation) 100 of dimensions, l=200 nm, w=100 nm. b, Schematic view of a nanorod in 3 different orientations: 0. θ=0° (reference position), 1. θ=30°, Φ=0° and 2. θ=60°, Φ=−90°. These orientations are also depicted on a 2D surface plot of the angular free energy. c, Line plots of the calculated free energy in θ along the dashed contour line in (b) denoting Φ=0°, for 4 different geometries of the trapping pocket (indentation): circular pocket of diameter 500 nm (squares), rectangular pockets (indentations) of dimensions l=200 nm, w=100 nm (circles), l=600 nm, w=100 nm (diamonds), l=600 nm, w=200 nm (triangles). The red curve R represents a fit to a harmonic potential of the form ΔU=½k_{θ}θ², where k_{θ}=9.1 k_{B}T and θ is in radians;

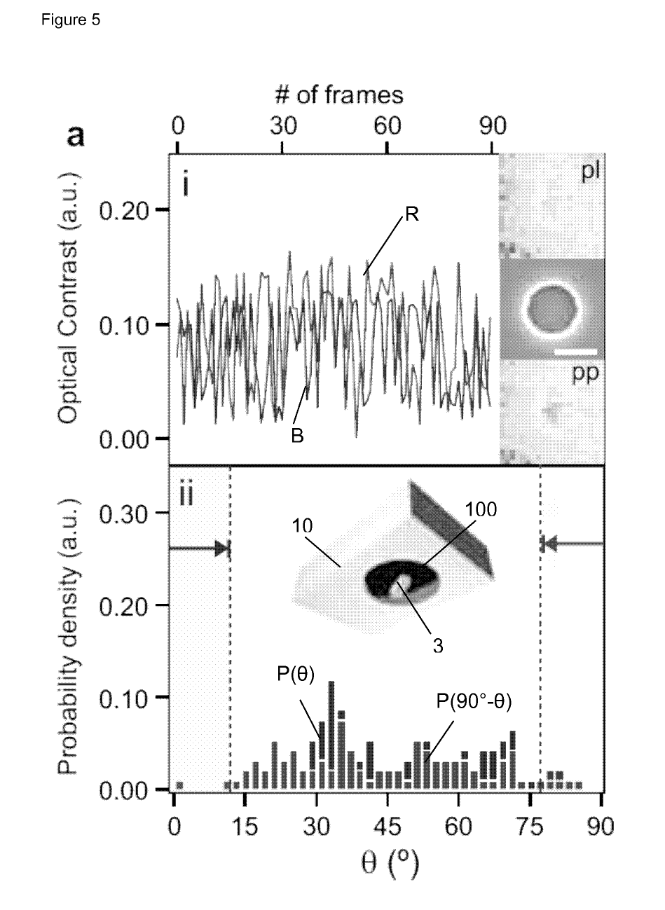

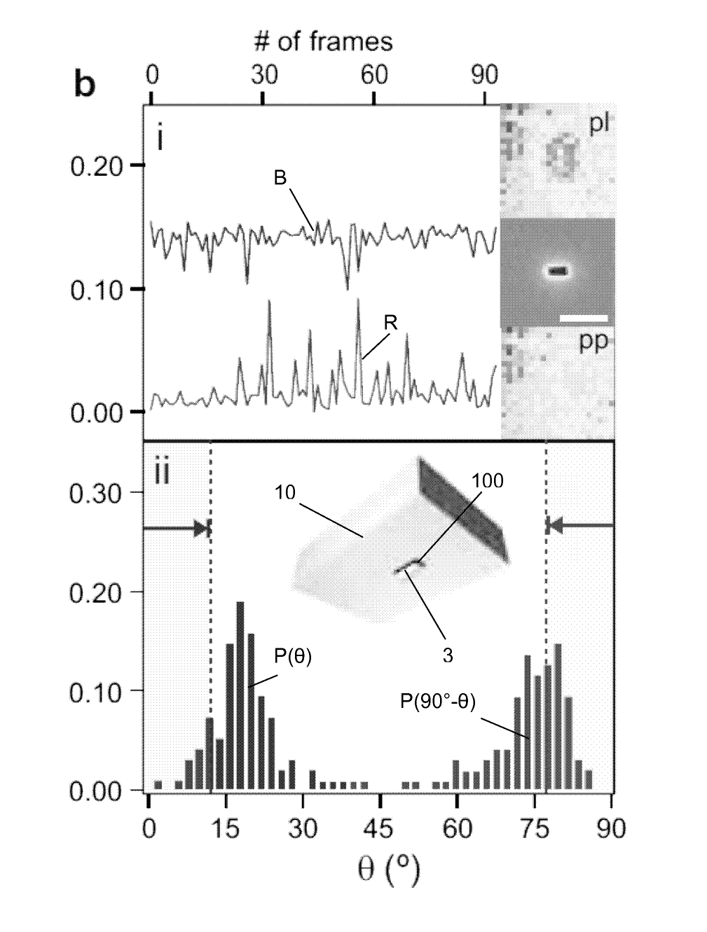

FIG. 5 shows angular dynamics of single nanorods 3 probed by laser scanning microscopy. The upper panels present normalized intensity (contrast) data, I, acquired at 1 kHz using parallel (B, I_{II}) and perpendicular (R, I_{⊥}) polarizations, for single nanorods 3, trapped by a, a circular pocket (indentation) 100 of diameter 500 nm, b, rectangular pockets of dimensions, l=200 nm, w=100 nm and c, l=600 nm, w=100 nm. Panel d presents data on a nanorod 3 immobilized on the substrate 10 surface 10a as a control measurement. Also shown in each case are SEMs of the trapping nanostructure (scale bars, 400 nm) and representative optical images in each polarization. The lower panels present angular density distributions, P(θ) (blue) and P(90°−θ) (red), derived from the temporal contrast data. Shaded vertical regions in each case denote the offset θ_{SNR}≈12° due to noise in the measurement;

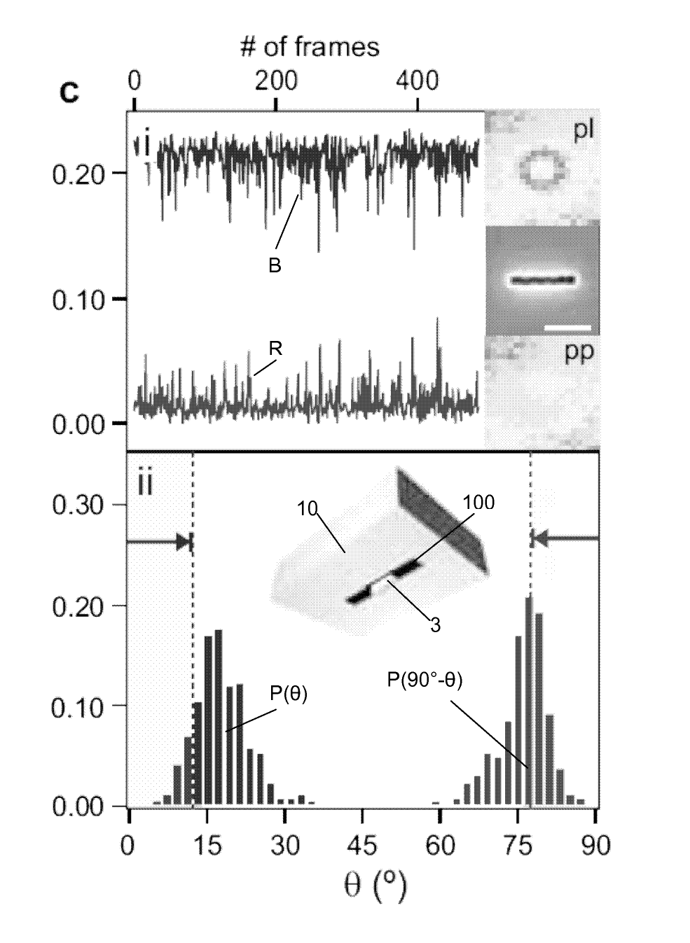

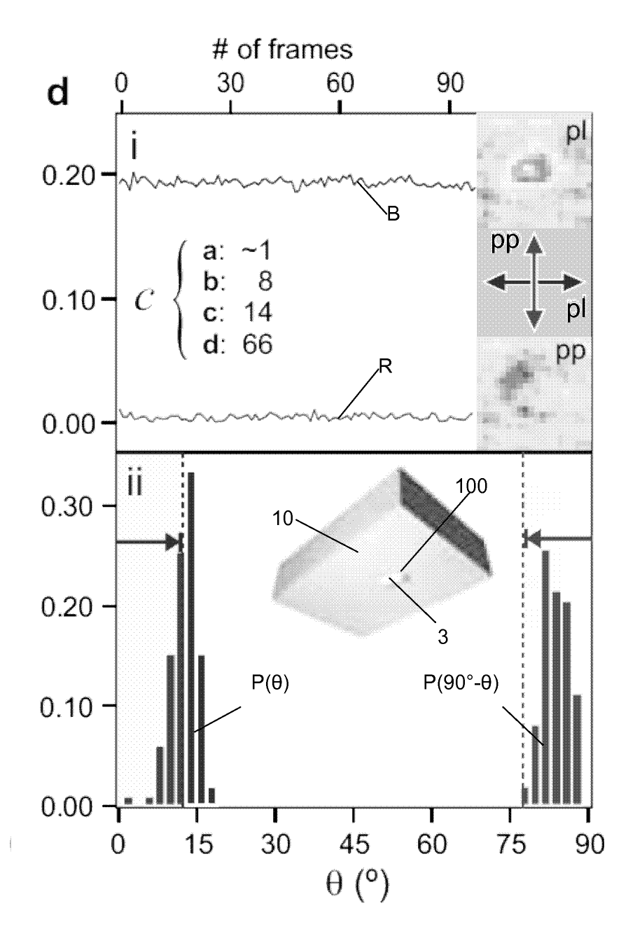

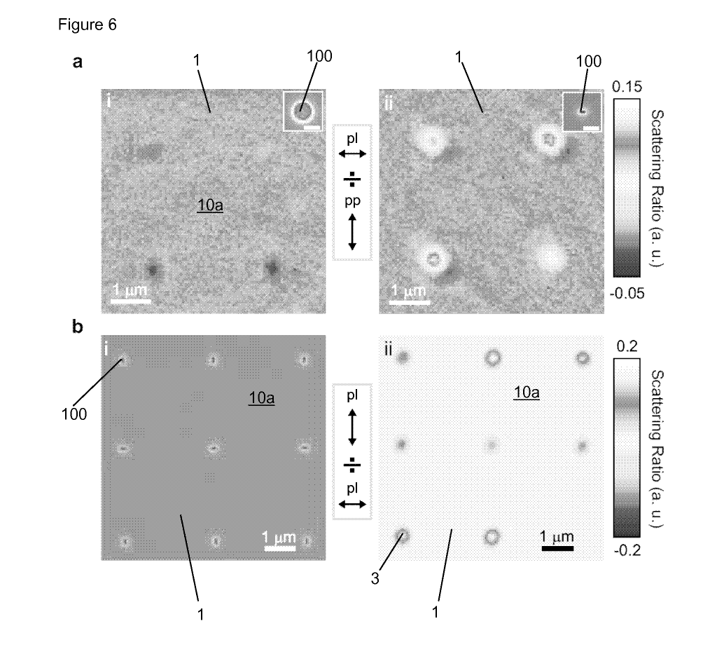

FIG. 6 shows trapping and aligning arrays of nanorods. a, Images of 2×2 arrays of nanorods trapped in cigar- and disc-shaped potentials created by rectangular and circular pockets indentations of dimensions l=200 nm, w=100 nm (left) and diameter 500 nm (right) respectively. The images were obtained by normalizing 100 averaged frames under parallel (pl) polarization excitation by a set of 100 frames collected with excitation polarization orthogonal (pp) to the trap axis, and then subtracting an average background value as an offset from the image. SEMs of the trapping nanostructures (indentations) 100 are displayed as insets (scale bars, 400 nm). b, Alignment of nanorods in rows of orthogonally oriented traps created by rectangular pockets (indentations 100) 100 of dimensions l=200 nm, w=100 nm (SEM on left). The image represents a time-series of measurements on single nanorods trapped in this 3×3 array processed as described in a, with the excitation polarizations oriented as depicted. Note that the location (3, 3) in this array is an unoccupied trap;

FIG. 7 shows orienting objects 3 of arbitrary shape and manipulating the state of a single trapped nanorod 3. a, A triangular nanoplate 3 experiences an orientation dependent free energy when trapped in a “shape-matched” potential well. The data symbols represent the free energy as a function of orientation of a nanoplate of side 200 nm and surface charge density −0.007 e/nm2 trapped in a slit of depth 100 nm. The black curve B denotes a harmonic fit to the free energy, revealing a high stiffness of confinement, k_{θ}=1200 pNnm. b, An “L-shaped” trap created by juxtaposing two orthogonally oriented rectangular pockets (indentation regions 101, 102) of dimensions l=200 nm, w=100 nm serves as a bistable angular potential well. An ellipsoid 3 of dimensions 160 nm×60 nm and charge q=−255e trapped in one arm (indentation region 101) of the well (state 0) experiences an angular free energy landscape, Uₑₗ depicted by the green curve G. Superposition of an optical potential given by Uₒₚₜ=500 pNnm sin² θ (red curve R) changes the total angular free energy of the rod, Uₜₒₜ=Uₑₗ+Uₒₚₜ (blue curve B). The rod 3 is now raised from state 0 to 1 and diffuses to the orthogonal orientation, state 2. Elimination of the optical field restores the angular free energy to the purely electrostatic form (green curve G), with the rod 3 now stably trapped in opposite arm (indentation region 102) of the well. The slit's S depth in these calculations is 100 nm.

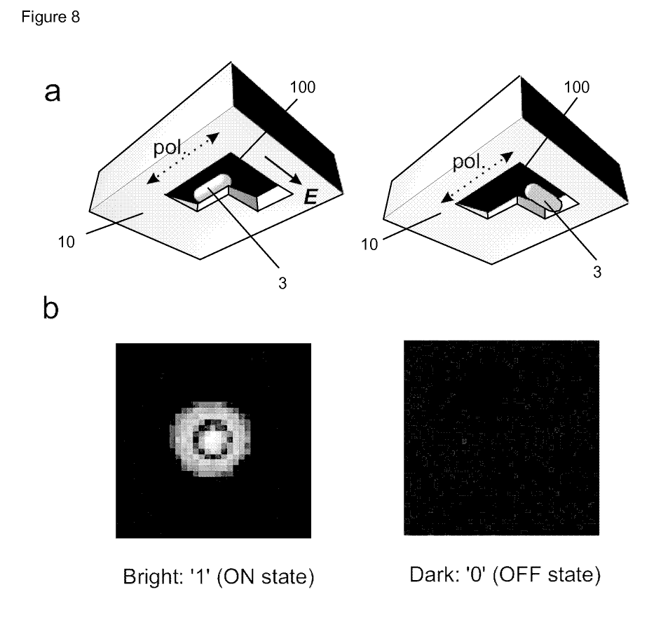

FIG. 8 shows in panel a a schematic of a single nanorod trapped in an L-shaped potential well and illuminated with light, whose polarization is denoted by the dotted arrow. Further in panel b experimentally obtained images of the scattering signal of the nanorod in each orientation are shown. The nanorod is bright (ON—‘1’) when parallel to the incident polarization and dark (OFF—‘0’) when oriented orthogonal to the polarization.

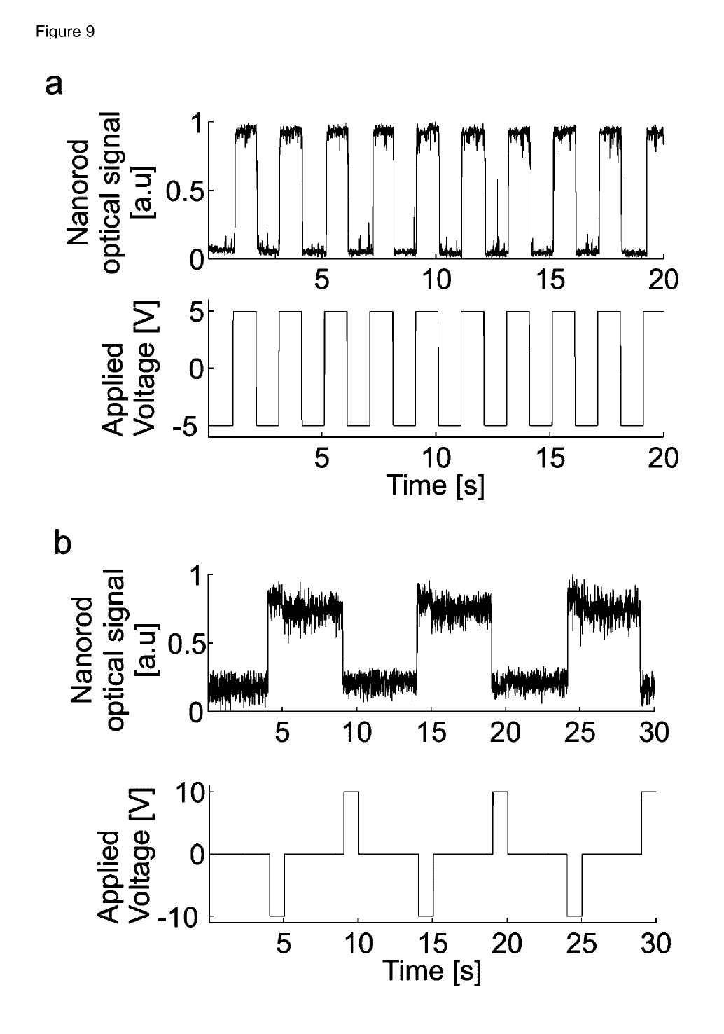

FIG. 9 shows electrical switching of a single nanorod, wherein panel a shows volatile switching, where an alternating square wave electric field is applied to the ends of a channel of the fluid phase above the L-shaped indentation of shown in FIG. 8a, wherein said electric filed is oriented with respect to the L-potential well as shown by the solid arrow in FIG. 8a. The signal from the nanorod alternates between bright and dark states synchronously with the applied field. Response times are under 1 ms. Further, panel b shows non-volatile switching, wherein transient rather than continuous electrical pulses are used to switch the nanorod from the bright to the dark state and back. The rod maintains its state until the application of the next pulse.

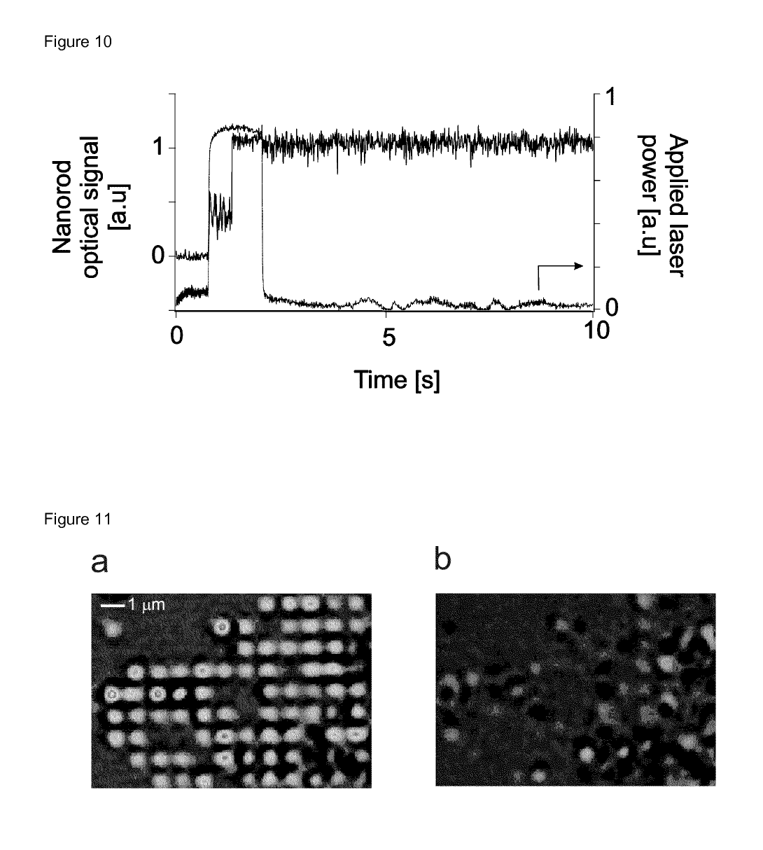

FIG. 10 shows non-volatile optical switching of a single nanorod, wherein a transient optical pulse from a second (Infrared) laser, whose polarization is orthogonal to the nanorod's current orientation is used to switch the rod from one arm of the L-potential well to the other. The rod maintains the new state long after the pulse is switched off, and

FIG. 11. shows electrical switching of a partially-filled array of nanorods. Application of an alternating square wave electrical field to extremities of the channel of the fluid phase, similar to the case shown in FIG. 9a, simultaneously switches an array of nanorods from the bright state (a) to the dark state (b).

The shape and spatial arrangement of nano-objects 3 in an assembly has profound effects on its interaction with light, and is a central theme in hybrid photonic devices, metamaterials and plasmonics. However, few techniques are capable of orienting and assembling individual nanoscale elements 3 of arbitrary shape and composition [2]. The optical gradient force offers angular control of metal nanorods [4], but requires high incident powers and is challenging to parallelize. We introduce a technique to orient single nanorods 3 with high spatial and angular precision, which is independent of the object's 3 dielectric function, and can be massively parallelized. This is particularly achieved using a device 1 forming an electrostatic fluidic trap [1] whose morphology is tailored to mimic the object's 3 shape [2].

Calculations show that each levitating entity 3 may be manipulated using external fields, opening doors to high resolution displays, optofluidic logic elements, non-volatile optical memories and reconfigurable 2D metamaterials, while providing a versatile chip-based light-mechanics platform at the nanoscale.

Although state-of-the-art particle assembly techniques permit highly precise spatial arrangement of nano-objects on a substrate, angular control of an individual anisotropic object such as a nanorod 3 remains to be demonstrated by these methods. In addition, the fact that matter is deposited directly onto a substrate surface limits prospects for reconfigurable assemblies.

We recently demonstrated an important step in the direction of reconfigurable nanophotonic assemblies, namely, highly parallel spatial trapping of levitating dielectric and metallic spheres and dielectric shells, 20-100 nm in diameter, using an array of electrostatic traps on a fluidic chip [1]. The experimental system consists of a slit structure S created by two parallel surfaces—one glass (top layer) 30 and the other SiO₂ (substrate 10); the SiO₂ surface 10a in turn carries indentations 100 that define the location and morphology of each trap 1. Negatively charged objects 3 in an aqueous suspension (electrolyte fluid phase 30) introduced into the slit S, sample the landscape by Brownian motion, fall into the electrostatic potential wells created by the surface indentations 100, and remain trapped for a time period that scales as

$${e}^{\frac{Δ U}{{k}_{B} T}} .$$

In a radially symmetric potential well, the electrostatic system free energy,U, is solely a function of the object's 3 location, confining it spatially [14] but permitting it to rotate freely in the polar (θ) dimension.

There are particularly two essential aspects of the present invention, namely the ability to orient a levitating nanophotonic element, such as a nanorod 3, so that it is in either a bright or dark state when illuminated with polarized light as indicated in FIGS. 1 and 2, as well as the ability to switch the nanorod 3 between these two states by locally applying an external optical or electrical field.

Particularly, the crux of the invention is a “bi-stable” or even a “multi-stable” electrostatic potential well, i.e., a potential which has two (or in fact even three) angular minima as shown in FIGS. 1 and 2 that are separated by an energy barrier, wherein the potential well supports two or three equally likely orientations of an object 3 separated by an energy barrier.

As shown in FIG. 1 for instance, such an indentation 100 of depth d formed in the substrate's surface 10a may comprise an L-shape, i.e., a first and a second indentation region (arm) 101, 102, wherein the first indentation region 101 extends longitudinally along a first extension direction E and comprises a length l along this direction E as well as a width w across this direction, and wherein the second indentation region 102 goes off a (common) free end 103 of the first indentation region 101 and extends longitudinally along a second extension direction E′ running perpendicular to the first extension direction E so that the contour 101a, 102a of the whole indentation (pocket) 100 delimiting the pocket 100 in the extension plane of the surface 10a of the substrate comprises an L-shape.

These features open up possibilities for a wealth of new applications. Consider now a rod-shaped object (nanorod) 3 levitated in the fluid phase 30 above indentation region 101 and aligned with it (trapped in the first minimum of the potential well) that has orientation dependent optical properties such as a Plasmon resonance, which is sensitive to a property of light such as its polarization P. Such a rod trapped in the bistable well formed by indentation 100 would either scatter light strongly when it is aligned with the polarization P of the exciting light field (ambient light or from an additional light source), giving a “bright state”, or conversely would scatter no light and give a “dark state” when the object 3 is aligned orthogonal to the incident polarization P, i.e. is levitated above the second indentation region 102.

Next, application of an external electric or optical field by means of at least one electrode 42 arranged adjacent to the indentation 100 or a laser 40 generating light L having a polarization P′ parallel to the desired orientation of the rod 3 places a torque on the rod 3 that switches it into the opposite orientation so that the nanorod 3 is aligned with indention region 102 and then resided in a dark state (see also FIG. 7b). Particularly, said electrode 42 stands for any configuration of a single or multiple electrodes that allow for generating an electric field that allows for switching the object 3 between the different orientations.

Preferably, pairs of first and second electrodes 42, 42a; 42, 42b may be used for switching the orientation of a single object 3 according to FIG. 1, wherein a first (e.g. ground) electrode 42 is preferably arranged between the two arms (indentation regions) 101, 102, namely where they meet each other, wherein a second electrode 42a, 42b is arranged along each arm 101, 102 on the other side of the respective arm 101, 102 with respect to the first electrode. Other configurations are also conceivable.

A similar configuration can be used for the situation according to FIG. 2. Here, the electrodes 42, 42a, 42b are arranged between the individual arms (indentation regions) 101, 102, 104 so that they particularly form pairs 42, 42a; 42, 42b; 42a, 42b for moving the respective object 3 to another orientation by means of an electric field between the respective pair of electrodes 42, 42a; 42, 42b; 42a, 42b. Particularly, the electrodes forming a specific pair 42, 42a; 42, 42b; 42a, 42b face each other across the respective indentation region 101, 102, 104. Also here, other configurations are also conceivable.

This serves is an extremely low power, rapid method to toggle the state of single light-emitting or optically responsive nano-object 3. Assembling a number of such objects 3 in high density arrays permits switching and readout operations to be performed in a highly parallel, rapid and low power fashion. Which allows for an efficient design of displays and data storage devices.

According to FIG. 2 the nanorod 3 can also be switched between more than two states thus allowing also states in between bright and dark (so called grey state).

For instance, the indentation 100 shown in FIG. 1 may comprise a third arm (indentation region 104) going off the common free end 103 so that the contour 101a, 102a, 104a of the indentation in the surface's 10a extension plane 100 forms a Y-shape, which encloses an angle of 135° with the first indentation region 101 as well as the second indentation 103 region. Thus, when the rod 3 is levitated above the third indentation region 104 and aligned with it as indicated by dashed lines in FIG. 2 the polarization P of incident light encloses an angle of 45° with the longitudinal axis of the rod 3 so that the rod 3 reflects less light (grey state).

Furthermore, experiments have shown that also spherically symmetric objects such as quantum dots 3′ can be levitated—as described above—above a separate first and second indentation region 101, 102 formed in the surface 10a of substrate 10 as well as switched as shown in FIG. 2A. The quantum dot 3′ may have a diameter in the range from 2 nm to 50 nm. The diameter/side lengths of the indentations regions which may have a circular or square contour for example may be in the range from 5 to 500 nm, for instance. Other dimensions may also be used.

Here, the substrate 10 adjacent to the first indentation region 101 is chosen such that the first indentation region 101 comprises a dielectric environment that differs from the dielectric environment of the second indentation region 102 leading to two different photophysical states of the quantum dot 3′, i.e., when the quantum dot 3 is in the first spatial location, i.e., trapped in the minima of an electrostatic potential generated with help of the first indentation region 101 of the substrate 10, the quantum dot is in a bright state meaning that it emits light away from the substrate when excited by suitable electromagnetic radiation, while it is in a dark state when residing in the second spatial location, i.e., trapped in the other minima generated with help of the second indentation region 102 of the substrate 10.

Now, application of an external electric or optical field by means of at least one electrode 42 arranged adjacent to the indentation regions 101, 102 or a laser 40 generating light L places a force on the rod 3′ that displaces it into the other spatial location so that the quantum dot 3′ can be switched from a bright state to a dark state and vice versa. Particularly, said electrode 42 stands for any configuration of a single or multiple electrodes that allow for generating an electric field that allows for switching the object 3′ between the different spatial locations.

Preferably, pairs of first and second electrodes 42, 42a may be used for switching the orientation of a single object 3′ according to FIG. 3, wherein a first (e.g. ground) electrode 42 is preferably arranged such that it opposes a second electrode 42a, wherein the indentation regions are arranged between said two electrodes 42, 42a. Other configurations may also be conceivable.

Furthermore, in all current methodologies of interest the material is deposited directly on a substrate. While this no doubt has its advantages, it poses a hurdle to reconfiguring members of an assembly in order to create switchable devices 1. This invention combines the advantages of excellent angular control of an arbitrarily-shaped nano-element 3 with that of levitation, namely rapid reconfiguration or switching the state of a single element 3. This unique combination of massively parallel spatial and dynamic angular control of levitating objects 3 opens up several avenues for novel device-based applications.

Since the state of each nanorod 3 can be switched to give a digital output (1 or 0) when illuminated with light of a given polarization P′ (see above), each rod 3 serves as a rewriteable bit of information. A high-density array of such rods 3 can be used as a super high resolution display (>50000 dpi), or as a low power rewriteable data storage device (˜1 GB/cm2). Furthermore X. Ni, et al., Science 2011 recently demonstrated the emerging area of light manipulation using arrays of nanorods on a 2D surface. This technique paves the way to ultra-thin plates for the manipulation of phase and directionality of a light beam. However, like all bottom-up nanofabrication methods it lacks reconfigurability since the optically active elements are fabricated on a substrate and hence immobilized. The present invention addresses dynamic switching of members of such an array to change the global and/or local phase response of the plate, leading to new reconfigurable ultra-thin plates for light manipulation at small and large scales.

In the present invention each “pixel unit” is a single nanorod 3 of dimensions ˜100 nm. In an analogous fashion, each nanorod 3 can be switched from strongly scattering (bright) to dark to weakly scattering (intermediate intensity). The advantages of using such an array of nanorods over some of the existing technologies for high resolution displays include (in addition to low power and reading in direct sunlight offered by E Ink):
Ultra high resolution—while the current e-reader screens may be perfect for reading text, they can't produce the detail required for industries that use engineering plans and technical diagrams. There are further benefits of a higher resolution display for rendering Asian character sets, and illustrations. So it's not just industry, but educational institutions that could benefit from such a display. As of 2011 Epson is looking into a 300 dpi resolution display (still about 200 times smaller than what this technology could offer).
Faster refresh rates—the speed of switching a small object such as a nanorod in a direct highly parallel fashion in an array will give display refresh rates of the order of 100 microseconds. Electrophoretic paper displays have traditionally not achieved the refresh rates of LCD displays, e.g., the refresh rate of the Kindle can be up to 1 s. As a result E Ink technology is currently unable to replace LCD displays of tablet/computing devices.
Lower power—once the nanorod state is switched, the field can be turned off and the “brightness or color state” of the pixel maintained. This is in contrast to the mechanism of E-Ink and recent developments in quantum dot displays where turning off the applied field deactivates the pixel,
Better color performance—higher saturation and accuracy of color. Extending this technology from resonant metallic nanorods that scatter light, to using narrow band spectroscopic emitters such as quantum dots could give more saturated color and improved color accuracy (pure R/G/B)
Brightness. The optical resonances of metal particles should give higher brightness for fundamental reasons compared to the pigments currently in use in E Ink.
Long life—non-fading displays—the optical properties of nanorods do not degrade easily as may well be the case with future quantum dot displays.

For verifying and testing angular control over nanophotonic elements, we chose nanorods as simple non-spherical (anisotropic) test objects for a theoretical and experimental study, and analyzed their behavior in electrostatic potential wells created by rectangular surface indentations in the fluidic slit (FIG. 3b). The spatial distribution of electrostatic potential in the trapping nanostructure 1 calculated by numerically solving the non-linear Poisson-Boltzmann equation [3] in 3D using COMSOL Multiphysics, reveals that the trap due to such a structure has the shape of a cigar (FIG. 3b), whose long and short axes can be tuned simply by changing the dimensions of the respective indentation (pocket) 100 formed in the surface 10a of the substrate 10. Engineering the morphology of the trap to closely mimic the shape and desired orientation of the object 3, should cause the system free energy, U to be not only a function of the spatial location of the object 3, but also of its orientation in the potential well. The system consists of an ellipsoid 3 of dimensions 160 nm×60 nm and fixed surface charge density embedded in an electrolyte 20, which is in turn bounded by charged surfaces representing the walls of the trapping nanostructure (surface 10a and top layer 30). The background electrolyte ionic strength (0.04 mM in these experiments) and an estimate of the particle and wall charge densities (0.01 e/nm²) can be obtained from conductivity, light scattering and electroosmotic flow measurements, respectively. The free energy of the system is found by summing the electrostatic field energies and entropies over all charges in the system [3]. The centre of mass of the ellipsoid 3 was positioned at the spatial minimum of the electrostatic free energy and the calculation performed as a function of object orientation (θ,Φ)). The resulting angular free energy landscape of a spatially trapped ellipsoid indeed reveals minima in both θ and Φ when the rod is aligned with the major axis of a cigar-shaped well (FIG. 4a); the depth of the well depends on the charge of the ellipsoid 3 and walls 10a, 30 of the nanostructure 1, the ionic strength of the solution 20 as well as the geometric parameters of the trap (FIG. 2c). The calculation additionally brings to light the following interesting features: first, similar to nanorod alignment in an optical focus, the confining potential can be well approximated by a harmonic potential, i.e.,

$$U ( θ ) = \frac{1}{2} {k}_{θ} {θ}^{2} for θ < \frac{π}{4} . \qquad ( Fig . 2 c )$$

Second, while the rod 3 is essentially free to rotate in Φ around θ=0°, for θ>30°, its motion in Φ is strongly restricted. This means that the further the object rotates in the x-y plane, the less likely rotation in the out-of-plane z dimension becomes. Thus in contrast to an optical focus, where the trap exerts no control on the nanorod 3 in the azimuthal dimension [4], rotational brownian fluctuations of an electrostatically trapped rod are confined predominantly to the polar dimension.

In order to experimentally demonstrate oriented trapping of a nano-object 3, we used silver nanorods 160 nm×60 nm in dimensions synthesized with a net negative surface charge in aqueous solution as test objects [2]. A suspension of rods 3 was introduced into the electrostatic landscape by the capillary effect, the flow was arrested and the dynamics of single trapped rods 3 were imaged using laser scanning microscopy at a rate of 1 kHz, with an excitation wavelength of 671 nm (FIG. 1a) and a half-wave plate in the beam path to set the direction of polarization of the linearly polarized incident beam (see Materials and Methods). The nanorods 3 under consideration have a broad longitudinal plasmon resonance centered at 776 nm, around which they strongly scatter light. Scattering at λ=671 nm arises solely from the resonance associated with the long axis of the rod and thus serves as a sensitive probe of the rod's orientation, θ relative to the incident polarization. The nanorod 3 scatters light most efficiently when aligned parallel to the polarization P (see FIGS. 1 and 2) of the incident field, and weakest when aligned orthogonal to it. Between these two limiting cases the light scattered by the object varies as cos² θ which thus yields a measure of its average orientation during the exposure time, σ. The optical field used here for imaging has an incident power of ˜1 W/cm², where the light-induced torque on the nanorod 3 and any resulting influence on its dynamics is utterly negligible.

Temporal intensities of trapped nanorods 3, recorded at the rate of 1 kHz over a period of ˜1 s, with incident polarizations parallel and perpendicular to the trap axis, was converted to angular probability density distributions. FIG. 5 displays measured probability densities, P(θ) (parallel excitation, blue histogram) and P(90°−θ) (perpendicular excitation, red histogram) for representative rods 3 trapped in potentials of various geometries. While the angular probability density distributions for trapping in a disc potential are essentially flat (FIG. 5a), those for cigar potentials show distinct peaks close to θ=0° (FIGS. 5b, c), similar to the case of a nanorod 3 immobilized on the substrate surface (FIG. 5d). This provides compelling evidence of the ability of a shape-matched electrostatic fluidic trap 1 to levitate and orient an anisotropic nano-object 3. Further scrutiny of the histograms however reveals distinct offsets—of the order of 15°—from the expected most probable orientation of the rod at θ=0° (FIG. 5d). This apparent offset arises from the measurement conditions and consists of two contributions: (1) the signal-to-noise ratio, SNR-60 and (2) time-averaging of the angular motion (i.e.a >>τ_{θ}), the effects of which we have confirmed in Brownian dynamics simulations. The angular probability density measurement on a stationary nanorod 3 immobilized on the slit surface convincingly demonstrates the large contribution to the offset from noise in the measurement: θ_{SNR}≈12° in the present investigation (FIG. 5d).

Furthermore, the ratio of the time-averaged intensities recorded for parallel and perpendicular polarizations, which we call the contrast-ratio,

$$c = \frac{{〈 {I}_{‖} 〉}_{t}}{{〈 {I}_{⊥} 〉}_{t}} ,$$

serves as a quantitative measure of the anisotropy of rod 3 orientation that can be related to a stiffness in a harmonic angular confining potential [4]. As FIG. 5 depicts, c increases progressively, beginning with 1 for the limiting case of a disc-shaped trap of aspect ratio 1 (rod has no preferred orientation), and attaining a maximum value of c=66 for an immobilized nanorod 3. Since the time averages of the two signals may be equated to their respective ensemble (thermal) averages in a confining potential, we have

$$c = \frac{{〈 {I}_{‖} 〉}_{t}}{{〈 {I}_{⊥} 〉}_{t}} = \frac{{〈 {cos}^{2} θ 〉}_{T}}{{〈 {sin}^{2} {θcos}^{2} φ 〉}_{T}} , \qquad ( 1 )$$

where we note that the signal in the perpendicular polarization carries the contribution of any azimuthal fluctuations of the rod 3. The right hand side of Equation (1) can be evaluated analytically for a harmonic potential, and under the assumption of limited rotation in Φ, is exclusively a function of the trap stiffness, k_{θ} in the polar dimension. We find that the simple relation

$$c ≅ \frac{{k}_{θ}}{{k}_{B} T}$$

relates the measured contrast ratio to the angular trapping stiffness. In addition, since k_{θ} [symbol] θ² [symbol] =k_{B}T from the equipartition theorem, the measured stiffness of confinement of a rod 3 yields an estimate of its root mean square angular displacement in the trap. Trap stiffnesses k_{θ}≈32 pNnm and 64 pNnm deduced for the nanorods shown in FIGS. 5b and c, correspond to r.m.s. angular displacements, θ_{RMS}=21° and 16° respectively. These values are comparable with those achieved for optical alignment of smaller gold nanorods [9], and maybe improved by finetuning the geometry of the well or changing the surface chemistry of the rod. E.g., working with a well of dimensions 200 nm×600 nm and using nanorods with twice the surface charge density would place the r.m.s. angular displacements in the range of θ_{RMS}<7°. We point out that the experimentally measured trap stiffnesses are higher than those predicted by the free energy calculations, e.g. for the l=600 nm, w=100 nm case, the value deduced from the experiment is k_{θ}≈14 k_{B}T (64 pNnm) (FIG. 5c) while the calculation predicts k_{θ}=9.1 k_{b}T (FIG. 4c); since the angular stiffness is linear in the charge of the object 3, tuning the charge densities in the calculation and accounting for the true shape of both the nanorod 3 and potential landscape (FIG. 2a) would enhance the agreement with the experiment. Nonetheless, the theory correctly captures the qualitative trends in the experiment and unequivocally establishes trap morphology as a tool to manipulate the orientation of single levitating nanorods 3. Additional factors that permit us to tune the trap performance e.g., depth of the well (ΔU), the stiffness of the potential (k_{θ}), and the relaxation time of the rod (τ_{θ}), include the solution's 30 (fluid phase) ionic strength (<0.1 mM in these experiments), the depth of the fluidic slit S, and the dielectric constant and viscosity of the fluid phase 30.

FIG. 6a further illustrates the behavior of rods 3 trapped in arrays of disc-shaped vs. cigar-shaped potentials. Each image represents a background-subtracted ratio of time-averaged stacks of images recorded in each polarization state. For disc-shaped traps (FIG. 4a (i)) the image is practically flat: there is no appreciable variation in contrast at the trap loci compared to the background, indicating the absence of a preferred orientation of the rod. The rods 3 rotate freely, with the amount of light they scatter insensitive to a switch in the direction of the incident polarization. Analogous images for rods 3 in arrays of cigar potentials (FIG. 4a (ii) and b (ii)) display a clear enhancement (attenuation) at the locus of each trap 1 when the excitation polarization is oriented parallel (orthogonal) to the trap axis. This demonstration of control of the orientation of individual levitating nano-objects is the key step in the assembly of larger scale, precisely assembled structures with photonic and/or plasmonic properties.

Chemical synthesis offers a variety of nanoscale materials with properties of interest in photonics but which are beyond reach with bottom-up fabrication methods, e.g. single crystalline material, faceted polyhedral, branched and hollow structures. The concept according to the invention as presented here for oriented assembly of nanorods 3 may be easily extended to objects of diverse shape, with an arbitrary but known foot print in the device 1 plane. As an example, FIG. 7 a presents an angular free energy calculation for the case of a triangular nanoplate 3 of side 200 nm. Even at a very low surface charge density ˜0.007 e/nm2, this object orients in a triangular potential well with an angular uncertainty, θ_{RMS}<4° (k_{θ}≈1200 pNnm).

Moreover, the fact that the aligned objects levitate in the fluid offers reconfigurability through the incorporation of external optical, hydrodynamic or electric fields. Optical fields in particular, present a facile well-controlled route to apply a power-dependent torque on a dielectric or metallic micro- or nano-object in solution [4]. Consider the bistable angular potential well (FIGS. 1 and 7b)—an “L-trap”—created by juxtaposing two orthogonal cigar-shaped traps (indentation regions 101, 102) as shown in FIG. 7b, and a 160 nm×60 nm nanorod 3 trapped in one arm (indentation region) 101 of this well. Transiently superimposing a red-detuned focused Gaussian beam (˜25 mW) polarized along the direction orthogonal to the rod applies an optical torque of about 500 pNnm to the rod 3.

The optical field thus dramatically lowers the free energy barrier between the two orientations and biases the rod 3 to the orthogonal state. This provides an elegant route to shuttle the rod 3 between (two or more) states with switching times in the sub ms regime.

Furthermore, since the trapping process can be easily parallelized in an array (FIG. 6) with element-to-element spacings smaller than the wavelength of light, scanning a focused beam L (see also FIGS. 1 and 2) across an assembly of oriented, levitating rods 3 opens up entirely new prospects for writing onto arrays by selectively addressing individual elements of the ensemble. The ability to toggle the state of a single nanophotonic entity, with switching contrasts >10 dB, has strong implications for digital photonic logic, ultra high resolution nanorod displays (>50.000 dpi), and light modulation—both in the near-field and far field e.g., frequency selective surfaces, polarizers and filters. The coupling of optical fields to levitating nanophotonic entities will not only pave the way to real-time tunable photonic assemblies but will also offer new opportunities in optomechanical manipulation at the nanoscale.

### Materials & Methods

### Surface Potential Measurements

The electrical potential at the plane of shear, zeta potential, ξ, gives a measure of the charge carried by a nanoparticle in solution is given by. Zeta potentials of the nanorods in these experiments were measured by phase analysis light scattering (PALS) using commercial instrumentation (Zetasizer Nano, Malvern Instruments). The measured zeta potential was used to arrive at an estimate of particle surface charge density, σₚ in C/m² using the semi-empirical equation

$${σ}_{p} = - ɛ {ɛ}_{0} κ ( \frac{{k}_{B} T}{j e} ) [ 2 sinh ( \frac{jy}{2} ) + ( \frac{8}{κ a} ) tanh ( \frac{j y}{4} ) ]$$

proposed by Loeb et al. where

$$y = \frac{ζ}{{k}_{B} T}$$

is the dimensionless zeta potential, j=1 is the valence of the counterions, and a=92 nm is the hydrodynamic diameter of the nanorod. A measured value of ξ=36±3 mV in a background electrolyte concentration of 0.13 mM, corresponds to a particle (object 3) charge in the range of −241 to −288 e per particle. The charge per particle assumed for the free energy calculations was −255 e.

### Device Fabrication & Sample Preparation

A single examplary device 1 consists of several fluidic slits S in parallel, with each slit 20 micrometers wide and around 200 nm deep. The slits were fabricated by lithographically patterning the surface of a ˜400 nm deep Silicon dioxide layer on a p-type silicon substrate and subsequent wet-etching the silicon dioxide layer to a depth of ˜200 nm in buffered HF (Ammonium fluoride-HF mixture, Sigma-Aldrich). The floors of these trenches were then patterned with submicron-scale features using electron beam lithography and subsequent reactive ion etching of the silicon dioxide to a depth of 100 nm. Fully functional fluidic slits S were obtained by irreversibly bonding the processed silicon dioxide-silicon substrates 10 with glass substrates 30 compatible with high-NA microscopy (PlanOptik, AG) using field-assisted bonding. Silver nanorods 3 were centrifuged and resuspended in deionized H₂O (18 MΩcm⁻¹) twice to remove traces of salt or other contaminants. Nanoslits S loaded with an aqueous suspension 30 of the nanorods 3 at a number density ca. 10¹³ p/ml were allowed to equilibrate at room temperature for ca. 1 h before commencing with optical measurements.

### Laser scanning microscope set-up according to FIG. 3

The Gaussian output beam of a 100 mW diode-pumped solid state laser at λ=671 nm (Pusch Opto Tech GmbH) is expanded by a 1:4 telescope lens system and directed through a two-axis acousto-optic deflector (AOD) (DTSXY, AA Opto-Electronic). A telecentric lens system (T) images the deflected beam at the focal plane of the microscope objective (1.4 NA, 100× UPLASAPO-Olympus) mounted on an inverted microscope (FIG. 3a). The excitation beam passes through a polarizer followed by a λ/2 wave plate which sets the polarization direction. The scanning rates of the AODs (50-100 kHz) are adjusted to achieve a uniform wide field illumination of the area of interest on the fluidic device. Light scattered by the particles and reflected by the device 1 are collected by the microscope objective and imaged onto a CMOS camera (MV-D1024E-160-CL-12, Photonfocus). FG denotes a function generator and BS, a 50/50 beam splitter.

As a further example silver nanorods 160 nm×60 nm have been electrostatically trapped in L-shaped bistable potential wells and switched using light and electrical forces as shown in FIG. 8, wherein the field strength of the electric field used for switching may be in the range between 1 V/mm to 5 V/mm with an object charge of approximately 200e. Further, for instance, a wavelength of 1064 nm may be used for generating an optical torque for switching. A probe laser wavelength of 671 nm may be used. Switching has been achieved in both volatile and non-volatile modes, cf. FIG. 9. In volatile switching, the field (electrical or optical) is applied continuously in order to maintain the state of the nanorod (either ON—bright, or OFF—dark) (cf. FIG. 9a). In non-volatile switching, a transient application of the electrical or optical field is sufficient to switch the rod from one state to the next. Thereafter the switched state is maintained after the field is turned off, until the application of the next “write pulse” (cf. FIG. 9b, FIG. 10). An electric field applied to an array of such levitated nanorods has been used to simultaneously switch the entire array from the bright to dark state (FIG. 11).

### REFERENCES

[1] Krishnan,M., Mojarad, N., Kukura, P. & Sandoghdar, V. Geometry-induced electrostatic trapping of nanometric objects in a fluid. Nature 467, 4 (2010).

[2] Celebrano, M, Rosman, C., Sonnichsen, C., Krishnan, M. Angular Trapping of Anisometric Nano-Objects in a Fluid. Nano Letters 12, 11 (2012).

[3] Krishnan, M. Electrostatic free energy for a confined nanoscale object in a fluid Journal of Chemical Physics 138 11 (2013).

[4] Ruijgrok, P. V., Verhart, N. R., Zijlstra, P., Tchebotareva, A. L. & Orrit, M. Brownian Fluctuations and Heating of an Optically Aligned Gold Nanorod. Physical Review Letters 107 (2011).

1. Device for placing at least one object in at least a first or a second orientation or in at least a first or a second spatial location, comprising:
a substrate (10) having a surface (10a),
at least one object (3) levitated above said surface (10a),
wherein the device (1) is designed to generate a potential, particularly an electrostatic potential with help of the substrate (10) for trapping the at least one object (3), the potential having at least a first minimum and a second minimum,
so that the at least one object (3) is oriented in the first orientation when being trapped in the first minimum, and oriented in the second orientation when being trapped in the second minimum, or
so that the at least one object (3′) is located in the first spatial location when being trapped in the first minimum, and located in the second spatial location when being trapped in the second minimum,
and wherein said at least one object (3) is trapped in one of said minima.

2. Device according to claim 1, characterized in that the substrate (10) further comprises at least one indentation (100) in said surface (10a) for generating said potential.

3. Device according to claim 2, characterized in that the device (1) further comprises a layer of a fluid phase (20) wetting the surface (10a) of the substrate (10) and the at least one indentation (100) for generating said potential, wherein particularly said fluid phase is an electrolytic fluid phase.

4. Device according to claim 3, characterized in that said fluid phase (20) has a low ionic strength, preferably an ionic strength below 1 mM, preferably below 0.1 mM.

5. Device according to claim 3, characterized in that the at least one object (3) is levitated above said at least one indentation in said fluid phase (20).

6. Device according to claim 3, characterized in that the device (1) comprises a transparent top layer (30) extending along the surface (10a) of the substrate (10), wherein particularly the top layer is transparent to light of a desired wavelength, wherein particularly said top layer (30) is made out of a glass, wherein said layer of the fluid phase (20) is confined between the surface (10a) of the substrate (10) and the top layer (30), and particularly wets said top layer (30).

7. Device according to claim 2, characterized in that the at least one indentation (100) comprises at least a first and a second indentation region (101, 102), or in that the at least one indentation is a group of indentations comprising a first and a second indention region which are separated from one another.

8. Device according to claim 7, characterized in that each indentation region (101, 102) comprises a boundary contour (101a, 102a) delimiting the respective indentation region (101, 102), wherein said boundary contours (101a, 102a) each mimic a contour (3a) of the at least one object (3) in a plane extending along the surface (10a) of the substrate (10).

9. Device according to claim 7, characterized in that the first indentation region (101) extends along a first extension direction (E), and the second indentation region (102) extends along a second extension direction (E′), wherein particularly the second indentation region (102) goes off a free end (103) of the first indentation region (101) along the second extension direction (E′), wherein when being oriented in the first orientation the at least one object (3) is levitated above the first indentation region (101) and aligned with the first indentation region (101), and wherein when being oriented in the second orientation (102) the at least one object (3) is levitated above the second indentation region (102) and aligned with the second indentation region (102).

10. Device according to claim 9, characterized in that the second extension direction (E′) runs perpendicular to the first extension direction (E), so that said at least one indentation (100) particularly comprises an L-shape.

11. Device according to claim 1, characterized in that said potential has a further third minimum so that the at least one object (3) is oriented in a third orientation when being trapped in the third minimum.

12. Device according to claim 9, characterized in that the at least one indentation (100) comprises a third indentation region (104), wherein particularly the third indentation region (104) goes off said free end (103) or is separated from the second and/or third indentation region (101, 102), wherein when being oriented in the third orientation the at least one object (3) is levitated above the third indentation region (104) and aligned with the third indentation region (104).

13. Device according to claim 12, characterized in that the third indentation region (104) encloses an angle with first and the second indentation region (101, 102) of 135° , respectively, so that particularly said at least one indentation (100) comprises a Y-shape.

14. Device according to claim 1, characterized in that said object (3) is formed as an elongated object extending along a longitudinal axis, particularly as a nanorod, particularly comprising a length and a width having an aspect ratio around or larger than two.

15. Device according to claim 14, characterized in that said at least one object (3) is designed such that it scatters light when its longitudinal axis is aligned with the polarization (P) of incident light and such that it does not scatter light in case its longitudinal axis is oriented orthogonal to the polarization of incident light (P).

16. Device according to claim 1, characterized by a means for illuminating the at least one object with light having a polarization (P) extending along the first orientation, particularly parallel to the first extension direction (E), so that the at least one object (3) scatters said light when being trapped in the first minimum, and does not scatter light or does scatter less light when being trapped in the second minimum

17. Device according to claim 1, characterized in that the object (3′) is formed as a quantum dot, wherein particularly said quantum dot is spherically symmetric.

18. Device according to claim 17, characterized in that the device is designed to provide a dielectric environment at the first spatial location and a dielectric environment at the second spatial location, wherein the two dielectric environments differ from each other, so that the quantum dot (3′) is able to emit light away from the substrate (10) when being trapped in the first minimum and is not able to emit light away from the substrate (10) or less light away from the substrate (10) when being trapped in the second minimum.

19. Device according to claim 17, characterized by a means for exciting the at least one object with electromagnetic radiation, such that the at least one object emits light away from the substrate (10) when being trapped in the first minimum and such that the at least one object emits no light or less light away from the substrate (10) when being trapped in the second minimum.

20. Device according to claim 1, characterized by a switching means (40, 42, 42a) which is designed to exert a torque on the at least one object (3) so as to switch the orientation of said object (3) from one of said orientations to another one of said orientations being a desired orientation or which is designed to exert a force on the at least one object (3′) so as to displace said object from one of said spatial locations to another one of said spatial locations being a desired spatial location.

21. Device according to claim 20, characterized in that said switching means (40) is designed to generate an electromagnetic radiation (L) exerting said force or torque on the at least one object (3), wherein particularly said switching means comprises a laser for generating said electromagnetic radiation, wherein particularly for switching the orientation of the at least one object (3) from the one of said orientations to said desired orientation said switching means (40) is designed to generate electromagnetic radiation (L) having a polarization (P′) extending along said desired orientation.

22. Device according to claim 20, characterized in that said switching means (42) is designed to generate an electric field exerting said force or torque on the at least one object (3), wherein particularly said switching means (42) comprises an electrode (42) or a pair of electrodes (42, 42a; 42, 42b) for generating said electric field, wherein particularly said electrode or pair of electrodes is arranged on the substrate (10), particularly adjacent to the at least one indentation (100) associated to the at least one object (3).

23. Device according to claim 1, characterized in that the device (1) comprises a plurality of objects (3, 3′), each object (3, 3′) being levitated above said surface (10a), wherein the device (1) is designed to generate a potential, particularly an electrostatic potential, for each of said objects (3, 3′) with help of the substrate (10) for trapping the respective object (3, 3′), the potentials having at least a first minimum and a second minimum,
so that each object (3) is oriented in the first orientation when being trapped in the respective first minimum, and oriented in the second orientation when being trapped in the respective second minimum, or
so that each object (3′) is located in the respective first spatial location when being trapped in the respective first minimum, and located in the respective second spatial location when being trapped in the respective second minimum,
and wherein each object (3, 3′) is trapped in one of said minima, wherein particularly the substrate (10) comprises a plurality of indentations (100) or a plurality of groups of indentations in said surface (10a) for generating said potential, each indentation (100) or group of indentations being associated to one of the objects (3, 3′), wherein particularly said layer of the electrolytic fluid phase (20) wets the surface (10a) and said indentations (100) or groups of indentations formed therein for generating said potentials, wherein particularly each object (3) is levitated above the respective indentation (100) or group of indentation in said fluid phase (20), wherein particularly said objects (3) are formed as elongated objects extending along a longitudinal axis, particularly as nanorods, or as quantum dots.

24. Device according to claim 23, characterized in that the indentations (100) or groups of indentations form an array of indentations, wherein said indentations or groups of indentations are particularly arranged on the nodes of a 2D lattice, particularly a square lattice.

25. Device according to claim 20, characterized in that said switching means (40) is designed to switch the orientation of a plurality of objects (3) or of all objects (3) of the array at once, or in that said switching means (40) is designed to displace a plurality of objects (3′) or all objects (3′) of the array from their respective current spatial position to the respective other spatial position being a desired spatial location.

26. Device according to claim 21, characterized in that the switching means (40) is designed to scan said objects (3) one after the other with the electromagnetic radiation (L) for switching the orientation of objects (3) from one of said orientations to another one of said orientations being a desired orientation.

27. Device according to claim 22, characterized in that the switching means (42) comprises a pair of electrodes or a plurality of electrodes each being associated to one of the indentations (100) for generating an electric field exerting a torque on the respective object (3) associated to the respective indentation (100) for switching the orientation of the respective object (3) from one of said orientations to another one of said orientations being a desired orientation, wherein particularly said electrodes are each arranged on the substrate (10) adjacent to the associated indentation (100).

28. Device according to claim 1, characterized in that the substrate comprises SiO₂ or other oxides with net negative or positive charge.

29. Device according to claim 1, characterized in that the fluid phase (20) is an aqueous or an organic solvent.

30. Display, wherein the display comprises a device according to claim 1.

31. Data storage device, wherein the data storage device comprises a device according to claim 1.
